(19) United States
(12) Patent Application Publication
(10) Pub. No.: US 2011/0148567 A1
(43) Pub. Date: Jun. 23, 2011

(54) Facilitating User Sensor Self-Installation

(76) Inventors: Kenneth G. Lafond, Brier, WA (US); Matthai Philipose, Seattle, WA (US)

(21) Appl. No.: 12/644,086

(22) Filed: Dec. 22, 2009

(51) Int. Cl. G05B 19/02

(52) U.S. Cl. 340/4.3

(57) ABSTRACT

User self-installation of a sensor network for activity monitoring may be facilitated by providing a computer system that prompts the user through the installation process. Particularly, the computer system may prompt the user to identify an object to which a sensor has been attached and the activities with which identified objects are associated. The computer may prompt with potential activities based on the object identified by the user. The elicited information may be used to automatically generate a model, which may be automatically improved over time by examining the history of sensor readings. Thereafter, based on the data produced by the sensors, the system identifies what activities are actually being completed.

### BACKGROUND

This relates generally to the use of sensor networks.

A sensor network is a collection of sensors that may be distributed throughout a facility in order to determine information about activities going on within that facility. Examples of sensor network applications include in-home, long-term health care, in-home care for elderly, home or corporate security, activity monitoring, and industrial engineering to improve efficiency in plants, to mention a few examples.

In many cases, the installation of the array is done by a technician who is experienced and knowledgeable about how to install such an array. However, in many applications, including in-home applications for example, the need for a technician to install and maintain the array greatly increases the cost. Thus, it is desirable to provide a sensor network that may be self-installed by a user or a user's family member or caretaker.

### BRIEF DESCRIPTION OF THE DRAWINGS

FIG. 1 is a perspective view of one embodiment of the present invention;

FIG. 2 is a schematic depiction of one embodiment of the present invention;

FIG. 3 is a flow chart for one embodiment of the present invention;

FIG. 4a is an object entry user interface for one embodiment; and

FIG. 4b is an activity entry user interface for one embodiment.

### DETAILED DESCRIPTION

In some embodiments, user self-installation of a sensor network can be improved or facilitated by asking the user to specify the activity monitored by the sensor. To facilitate this practice, the user may be provided with an electronic device that allows the user to associate sensors with objects or states, and displays user selectable activity options and/or allows the user to enter their own options. Using this elicited information, the device may automatically build a model, monitor the sensor data it receives over time and identify what activities are being undertaken.

As a simple example, the user may indicate that a shake sensor was placed on a refrigerator door and that the activities related to the refrigerator door might be getting a drink, preparing a meal, filling the refrigerator with groceries, getting ice, or determining whether additional groceries may be needed. Thus, when the refrigerator door sensor fires, the system has a variety of options to consider when identifying why the user was opening the refrigerator. However, using a sensor network, the system can obtain additional information from which it may be able to probabilistically identify the actual activity. For example, if, within a certain time, the user opened another drawer that includes silverware and, still another cabinet that includes plates, the probability may be higher that the user is preparing a meal.

Feedback may be obtained to determine whether or not this determination is correct. Based on the feedback received and/or on automated machine learning algorithms, the machine may improve its internal model of sensors, objects, states, and activities. A state relates to an object and defines its current condition (e.g. on, off, open, closed, operating, not operating, etc.).

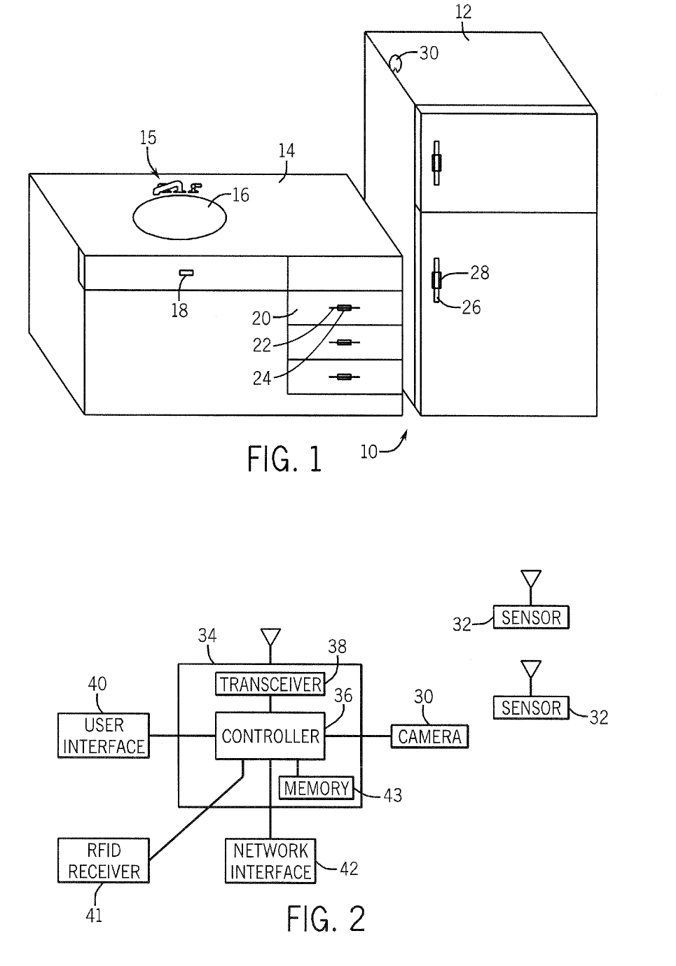

Thus, referring to FIG. 1, a home installation is illustrated. It is applicable to home health care, care for the elderly, or home monitoring. However, the present invention is not limited to these applications.

Thus, FIG. 1 shows a user's kitchen, including a refrigerator 12, a counter 14, a sink 16, a faucet 15, and a sensor 18 on the counter front. The sensor 18 may be a proximity sensor. Typically sensors for sensor networks are wireless and battery powered. A drawer 20 may include a handle 22 with a touch sensor 24. The refrigerator 12 may include a handle 26 with a touch sensor 28. A camera 30 may provide information about what is actually happening. Thus, the information from the camera 30 may provide feedback, which may be utilized by the machine to learn what activities correspond to received sensor signals and signal timing.

Referring to FIG. 2, the sensor network, in accordance with one embodiment, may include a large number of sensors 32, logically coupled to a computer 34. The computer 34 may include a wireless transceiver 38 and a controller 36. The camera 30 may be directly connected or wirelessly connected to the computer 34. The controller 36 may include storage that stores software and/or gathered sensor data. A network interface 42 may enable the computer 34 to interface wirelessly over the Internet or over a cellular network with a remote operations center. A user interface 40 provides the user with a device to enter selections or view system status and output, such as a touch screen display. A radio frequency identifier (RFID) reader or receiver 41 and memory 43 may also be coupled to the computer.

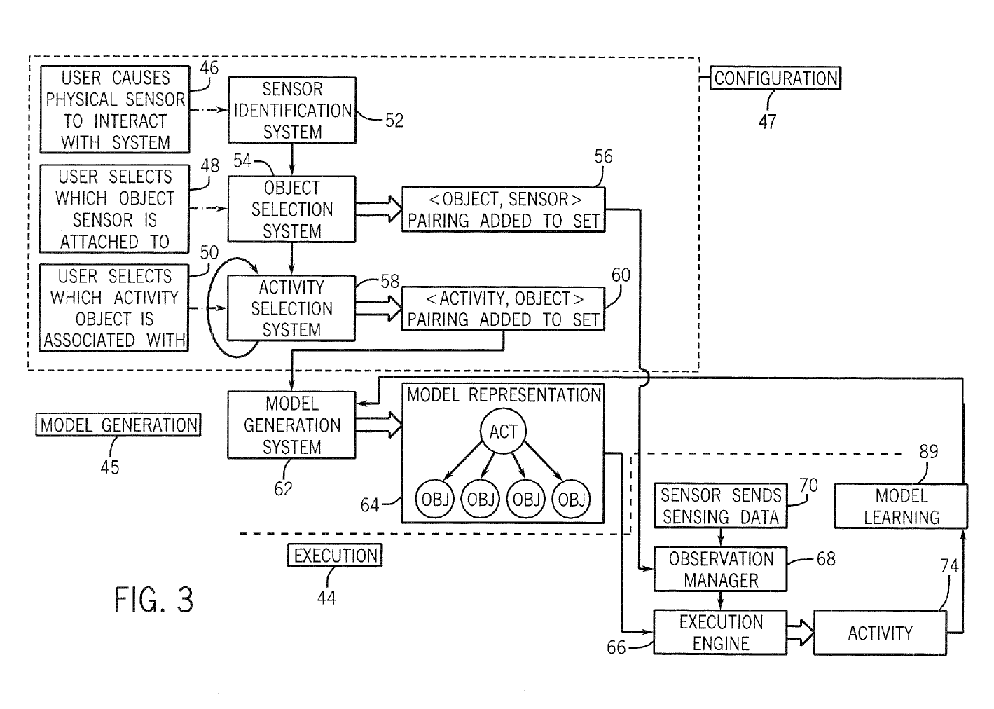

Referring to FIG. 3, a configuration sequence 47 may be followed by model generation 45 and then an execution sequence 44. In the configuration sequence 47, a new sensor is configured and, in the execution sequence 44, the sensor is actually used to collect information about activities being done by the user. The configuration sequence 47 is repeated for each added sensor.

Thus, in the initial configuration sequence 47 for each sensor, the user causes the selected physical sensor to interact with the system, as indicated in block 46. The system then detects the sensor 32 at 52. This may be done by reading an RFID tag on the sensor using the RFID reader 41 so that the sensor 32 is identified. Other identification methods may include, but are not limited by, using infrared wireless communication, pushing buttons on the sensor 32 and the user interface 40 simultaneously, pushing a button on the user interface 40 while shaking the sensor 32, having a bar code reader on the user interface 40 to read a 1D or 2D code on the sensor 32, or using keyboard entry via computer 34 or user interface 40 of a sensor identifier number. For example, the sensor may have a bar code that identifies the type of sensor (e.g. motion, touch proximity, etc) and its identifier.

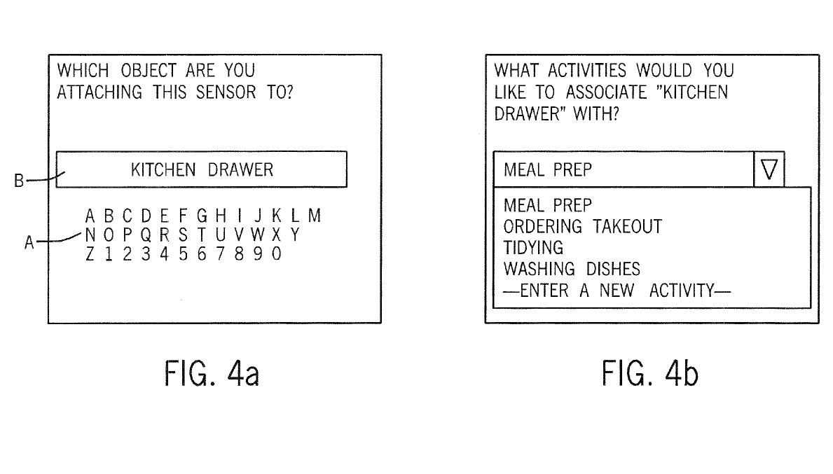

Then, an object selection system may be implemented in block 54. The user may select or identify what object the sensor is attached to in block 48 using a user interface 40 that may be the interface shown in FIG. 4a in one embodiment. The sensors may be adapted for easy installation, for example, using an adhesive strip with a peel off cover. The selection may be entered on the user interface, for example, via a touch screen.

The user interface 40 may provide a list of objects within the home to select from, for example, by selecting the corresponding picture on a touch screen. As another example, the user can select the first letter of the object at A to get a display of objects in window B starting with that letter as indicated in FIG. 4a. The user may also enter new objects to be added to any current list. Then the object sensor pair is added to the set representing the sensor network, as indicated by block 56.

The user may also select the activities the sensor is intended to be associated with in block 50. The activity selection system 58 is used for this purpose. Each object may be associated with multiple activities in block 60. In one embodiment, shown in FIG. 4b, the user interface may be a mouse selectable drop down menu that includes activities (e.g. meal preparation, ordering take out, etc.) potentially applicable to the previously identified object, while still allowing the user to identify a new or existing activity not yet in the list (i.e. “enter a new activity”). In the example shown in FIGS. 4a and 4b, the user identified the object to which the sensor was attached as a kitchen drawer. At this point, the flow is iterated for each sensor identified by the user, either configuring or reconfiguring each sensor, each initiated through block 46.

In block 62, a model generation system generates a model 64 of the relationships between activities and objects, as provided by the user, and as learned by the system thereafter.

During the execution 44, each sensor sends data 70 to the observation manager 68 in computer 34 via transceiver 38 in one embodiment. The observation manager 68 collects sensor information and any other feedback, such as camera or user interface feedback as inputs. Based on this information and the model 64, the execution engine 66 determines what activity was being done as indicated in block 74. This determination may then be used in a model learning module 89 to improve the model 64 based on experience.

Model optimization using machine learning techniques may be implemented in software, hardware, or firmware, as indicated in FIG. 3. In software embodiments, the software may be implemented by instructions stored on a computer readable medium such as a semiconductor, optical or magnetic memory, such as memory 43. The instructions may be executed by the controller 36. The model optimization operation begins at 62, where user inputs are synthesized into a model. Over time, sensor data is collected by the observation manager 68. The data and the activity determined by the data are analyzed by the model learning block 89. Ground truth may also be considered, gathered by video analysis of the camera data or by asking the user via the user interface at key intervals to verify the activity he or she is doing. The model 64 may then be updated appropriately.

For example, the activity of operating the faucet (detected by proximity sensor 18), followed by the activity of opening the refrigerator door (as sensed by touch sensor 28), followed by the activity of pulling a dish out of the cabinet (detected by sensor 24), all within a certain window of time could indicate the activity of food preparation, rather than the task of preparing a grocery shopping list. At periodic intervals, camera information or user inquiries may be used to refine the model of how the sensors, objects, states, and activities relate. For example, the user can be asked to indicate what task the user just did, via the user interface. Thus, the computer can then reinforce over time that, given a sensor dataset with given time, a certain activity is more probable. In this way, the system can identify what activities the user is doing, in many cases without the need for technician installation.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
automatically electronically querying a user to input an association between a sensor, applied by the user to an object, and a user activity or state that the user believes would be associated with that object and sensor.

2. The method of claim 1 including automatically building a model to convert sensor readings into activities.

3. The method of claim 2 including using ongoing sensor readings and inputs from the user to adapt the model.

4. The method of claim 1 including, in response to the user identifying a sensor, automatically requesting the user to enter the activities sensed by said sensor.

5. The method of claim 1 including automated monitoring of a sensor network to determine a pattern of sensor activation and, based on said pattern of sensor activation, identifying the activity being undertaken by a user.

6. The method of claim 1 including providing a user interface including enabling a user to select from or add to a list.

7. The method of claim 1 including providing a user interface for the user to identify an object to which a sensor has been attached.

8. The method of claim 7 including automatically determining a list of activities that may be undertaken based on the object identified previously and, in response to said determination, providing a user interface display that indicates those activities for the user to select from.

9. A computer readable medium storing instructions to enable a computer to:
query a user to input an association between a sensor, applied by the user to an object, and a user activity or state that the user believes would be associated with that object and sensor.

10. The medium of claim 9 further storing instructions to build a model to convert sensor readings into activities.

11. The medium of claim 10 further storing instructions to use ongoing sensor readings and inputs from the user to adapt the model.

12. The medium of claim 9 further storing instructions to automatically request the user to enter the activities sensed by the sensor in response to the user identifying a sensor.

13. The medium of claim 9 further storing instructions to provide a user interface for the user to identify an object to which a sensor has been attached.

14. The medium of claim 13 further storing instructions to determine a list of activities that may be undertaken based on the object identified previously and, in response to said determination, provide a user interface display that indicates those activities for the user to select from.

15. An apparatus comprising:
a sensor network; and
a control for said sensor network, said control to automatically electronically query a user to input an association between a sensor, applied by the user to an object, and a user activity or state that the user believes would be associated with that object and sensor.

16. The apparatus of claim 15, said control to learn based on sensor activations which of a plurality of potential activities associated with a sensor is the activity actually being done when the sensor is activated.

17. The apparatus of claim 16, said control to use signals from at least two sensors to determine an activity being done by a user.

18. The apparatus of claim 17, said control to automatically modify, based on user inputs, a model associating inputs from more than one sensor and an associated user activity.

19. The apparatus of claim 15 to automatically display a user interface to associate an activity with a sensor in response to the user's identification of a sensor.

20. The apparatus of claim 19, said apparatus to automatically offer the user a list of possible activities, said list developed based on the location of the sensor.
